(19) United States
(12) Patent Application Publication
(10) Pub. No.: US 2022/0217717 A1
(43) Pub. Date: Jul. 7, 2022

(54) Timing Information Delivery on New Radio V2X Sidelink

(71) Applicant: Nokia Technologies Oy, Espoo (FI)

(72) Inventors: Jorma Johannes KAIKKONEN, Oulu (FI); Sami-Jukka HAKOLA, Kempele (FI); Timo KOSKELA, Oulu (FI)

(21) Appl. No.: 17/607,529

(22) PCT Filed: Apr. 30, 2020
(86) PCT No.: PCT/EP2020/062104

§ 371 Date: Oct. 29, 2021

Related U.S. Application Data
(60) Provisional application No. 62/842,606, filed on May 3, 2019.

(51) Int. Cl. H04W 72/04; H04W 56/00

(52) U.S. Cl. CPC H04W 72/0446; H04W 56/0005

(57) ABSTRACT

In accordance with example embodiments there is at least a method and apparatus to perform determining, by a network node of a communication network, a configuration for at least one synchronization signal block for communication of at least one sidelink communication with at least one user equipment of the communication network; and based on the determining, sending towards the user equipment information including an indication of the configuration for use by the user equipment to receive the at least one sidelink communication. Further, at least a method and apparatus to perform receiving from user equipment of a communication network, by a network device of the communication network, information including a configuration for at least one synchronization signal block for communication of at least one sidelink communication with the user equipment; and based on the information, using the configuration to receive the at least one sidelink communication.

### TECHNICAL FIELD

The teachings in accordance with the exemplary embodiments of this invention relate generally to 3GPP New Radio physical layer design and, more specifically, relate to Sidelink synchronization procedure for New Radio.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
DL downlink
DMRS demodulation reference signal
gNB 5G Node B
GNSS global navigation satellite system
NR new radio
PSBCH physical SL broadcast channel
PSCCH physical sidelink control channel
PSSCH physical sidelink shared channel
PSS primary synchronization signals
PSSS primary sidelink synchronization signals
S-PSS SL primary synchronization signal
SL-SSB SL synchronisation signal block
SSS secondary synchronization signals
SSSS secondary sidelink synchronization signals
SL sidelink
SL-BWP SL bandwidth part
TDD time division duplex
UE user equipment
UL uplink
V2X vehicle-to-everything

In accordance with standards from 3GPP, to realize the subframe-level synchronization between devices, such as in different cells, a UE transmitting doing discovery and synchronization procedures receives a signaling indication of an evolved Node B (eNB) or gNB located nearby in a network or cell edge. Here, a user equipment can perform Sidelink communications on resources configured by the network, where the Sidelink communications can include a Primary Sidelink Synchronization Signal (PSSS) and/or a Secondary Sidelink Synchronization Signal (SSSS).

Example embodiments of the invention as described herein work to provide novel operations for improving such communications associated with the Sidelink communications.

### SUMMARY

In an example aspect of the invention, there is an apparatus, comprising: at least one processor; and at least one memory including computer program code, where the at least one memory and the computer program code are configured, with the at least one processor, to cause the apparatus to at least: determine, by a network node of a communication network, a configuration for at least one synchronization signal block for communication of at least one sidelink communication with at least one user equipment of the communication network; and based on the determining, send towards the user equipment information comprising an indication of the configuration for use by the user equipment to receive the at least one sidelink communication.

In another example aspect of the invention, there is a method which can be performed by an apparatus as disclosed herein, comprising: determining, by a network node of a communication network, a configuration for at least one synchronization signal block for communication of at least one sidelink communication with at least one user equipment of the communication network; and based on the determining, sending towards the user equipment information comprising an indication of the configuration for use by the user equipment to receive the at least one sidelink communication.

A further example embodiment is a method comprising the method of the previous paragraph, wherein the determined configuration comprises at least one configuration for slot timing of the at least one synchronization signal block for communication of the at least one sidelink communication, wherein the slot timing is based on at least one of uplink configured slots or downlink configured slots, wherein the information comprises an indication of the at least one of the uplink configured slots or the downlink configured slots for the at least one synchronization signal block for the communication of the at least one sidelink communication, wherein the determining the configuration comprises determining flexible slots of the at least one of the uplink configured slots or the downlink configured slots to accommodate the at least one sidelink communication, wherein the information comprises the at least one of the uplink configured slots or the downlink configured slots are identified by numbering at least to indicate a logical index of at least one slot for the at least one synchronization signal block for the communication of the at least one sidelink communication, wherein the flexible slots of the at least one slot for the at least one synchronization signal comprises one of partial or full slots of the at least one of the uplink configured slots or the downlink configured slots, wherein a validity of the flexible slots is dependent on a time division allocation of the at least one sidelink communication fitting into the uplink configured slots, wherein fitting is accounting for reception and transmission switching gaps of the flexible slots, wherein the numbering is over a whole pattern repetition period associated with the at least one of the uplink configured slots or the downlink configured slots, wherein the whole pattern repetition period is 20 ms, wherein the determining the configuration comprises: determining at least one full slot of the at least one of the uplink configured slots or the downlink configured slots for the at least one sidelink communication; and based on at least the determined at least one slot, determining a slot index of at least one slot for the at least one synchronization signal block for the communication of the at least one sidelink communication, wherein the slot index is identified in the information based on at least a frequency and a number of slots of a radio frame for slot index for communication of the at least one sidelink communication, and/or wherein the determined configuration comprises an uplink or downlink configuration for the at least one sidelink communication as determined from a serving cell slot configuration.

A non-transitory computer-readable medium storing program code, the program code executed by at least one processor to perform at least the method as described in the paragraphs above.

In another example aspect of the invention, there is an apparatus comprising: means for determining, by a network node of a communication network, a configuration for at least one synchronization signal block for communication of at least one sidelink communication with at least one user equipment of the communication network; and means, based on the determining, for sending towards the user equipment information comprising an indication of the configuration for use by the user equipment to receive the at least one sidelink communication.

In accordance with the example embodiments as described in the paragraph above, at least the means for determining and sending comprises a network interface, and computer program code stored on a computer-readable medium and executed by at least one processor.

A further example embodiment is an apparatus comprising the apparatus of the previous paragraphs, wherein the determined configuration comprises at least one configuration for slot timing of the at least one synchronization signal block for communication of the at least one sidelink communication, wherein the slot timing is based on at least one of uplink configured slots or downlink configured slots, wherein the information comprises an indication of the at least one of the uplink configured slots or the downlink configured slots for the at least one synchronization signal block for the communication of the at least one sidelink communication, wherein the determining the configuration comprises determining flexible slots of the at least one of the uplink configured slots or the downlink configured slots to accommodate the at least one sidelink communication, wherein the information comprises the at least one of the uplink configured slots or the downlink configured slots are identified by numbering at least to indicate a logical index of at least one slot for the at least one synchronization signal block for the communication of the at least one sidelink communication, wherein the flexible slots of the at least one slot for the at least one synchronization signal comprises one of partial or full slots of the at least one of the uplink configured slots or the downlink configured slots, wherein a validity of the flexible slots is dependent on a time division allocation of the at least one sidelink communication fitting into the uplink configured slots, wherein fitting is accounting for reception and transmission switching gaps of the flexible slots, wherein the numbering is over a whole pattern repetition period associated with the at least one of the uplink configured slots or the downlink configured slots, wherein the whole pattern repetition period is 20 ms, wherein the determining the configuration comprises: determining at least one full slot of the at least one of the uplink configured slots or the downlink configured slots for the at least one sidelink communication; and based on at least the determined at least one slot, determining a slot index of at least one slot for the at least one synchronization signal block for the communication of the at least one sidelink communication, wherein the slot index is identified in the information based on at least a frequency and a number of slots of a radio frame for slot index for communication of the at least one sidelink communication, and/or wherein the determined configuration comprises an uplink or downlink configuration for the at least one sidelink communication as determined from a serving cell slot configuration.

In another example aspect of the invention, there is an apparatus, comprising at least one processor; and at least one memory including computer program code, where the at least one memory and the computer program code are configured, with the at least one processor, to cause the apparatus to at least: receive from user equipment of a communication network, by a network device of the communication network, information comprising a configuration for at least one synchronization signal block for communication of at least one sidelink communication with the user equipment; and based on the information, use the configuration to receive the at least one sidelink communication.

In another example aspect of the invention, there is a method which can be performed by an apparatus as disclosed herein, comprising: receiving from user equipment of a communication network, by a network device of the communication network, information comprising a configuration for at least one synchronization signal block for communication of at least one sidelink communication with the user equipment; and based on the information, using the configuration to receive the at least one sidelink communication.

A further example embodiment is a method comprising the method of the previous paragraph, wherein the determined configuration comprises at least one configuration for slot timing of the at least one synchronization signal block for communication of the at least one sidelink communication, wherein the slot timing is based on at least one of uplink configured slots or downlink configured slots, wherein the information comprises an indication of the at least one of the uplink configured slots or the downlink configured slots for the at least one synchronization signal block for the communication of the at least one sidelink communication, wherein the information comprises an indication of flexible slots of the at least one of the uplink configured slots or the downlink configured slots accommodating the at least one synchronization signal block for the at least one sidelink communication, wherein the information comprises the at least one of the uplink configured slots or the downlink configured slots are identified by numbering at least to indicate a logical index of at least one slot for the at least one synchronization signal block for the communication of the at least one sidelink communication, wherein the flexible slots of the at least one slot for the at least one synchronization signal comprises one of partial or full slots of the at least one of the uplink configured slots or the downlink configured slots, wherein a validity of the flexible slots is dependent on a time division allocation of the at least one sidelink communication fitting into the uplink configured slots, wherein fitting is accounting for reception and transmission switching gaps of the flexible slots, wherein the numbering is over a whole pattern repetition period associated with the at least one of the uplink configured slots or the downlink configured slots, wherein the whole pattern repetition period is 20 ms, wherein the information comprises a slot index of at least one slot for the communication of the at least one sidelink communication, wherein the slot index is based on at least one full slot of the at least one of the uplink configured slots or the downlink configured slots for the at least one synchronization signal block for the at least one sidelink communication, wherein the slot index is identified in the information based on at least a frequency and a number of slots of a radio frame for slot index for the at least one synchronization signal block for communication of the at least one sidelink communication, and/or wherein the configuration comprises an uplink or downlink configuration for the at least one sidelink communication as determined from a serving cell slot configuration.

A non-transitory computer-readable medium storing program code, the program code executed by at least one processor to perform at least the method as described in the paragraphs above.

In yet another example aspect of the invention, there is an apparatus comprising: means for receiving from user equipment of a communication network, by a network device of the communication network, information comprising a configuration for at least one synchronization signal block for communication of at least one sidelink communication with the user equipment; and means, based on the information, for using the configuration to receive the at least one sidelink communication.

In accordance with the example embodiments as described in the paragraph above, at least the means for receiving and using comprises a network interface, and computer program code stored on a computer-readable medium and executed by at least one processor.

A further example embodiment is an apparatus comprising the apparatus of the previous paragraphs, wherein the determined configuration comprises at least one configuration for slot timing of the at least one synchronization signal block for communication of the at least one sidelink communication, wherein the slot timing is based on at least one of uplink configured slots or downlink configured slots, wherein the information comprises an indication of the at least one of the uplink configured slots or the downlink configured slots for the at least one synchronization signal block for the communication of the at least one sidelink communication, wherein the information comprises an indication of flexible slots of the at least one of the uplink configured slots or the downlink configured slots accommodating the at least one synchronization signal block for the at least one sidelink communication, wherein the information comprises the at least one of the uplink configured slots or the downlink configured slots are identified by numbering at least to indicate a logical index of at least one slot for the at least one synchronization signal block for the communication of the at least one sidelink communication, wherein the flexible slots of the at least one slot for the at least one synchronization signal comprises one of partial or full slots of the at least one of the uplink configured slots or the downlink configured slots, wherein a validity of the flexible slots is dependent on a time division allocation of the at least one sidelink communication fitting into the uplink configured slots, wherein fitting is accounting for reception and transmission switching gaps of the flexible slots, wherein the numbering is over a whole pattern repetition period associated with the at least one of the uplink configured slots or the downlink configured slots, wherein the whole pattern repetition period is 20 ms, wherein the information comprises a slot index of at least one slot for the communication of the at least one sidelink communication, wherein the slot index is based on at least one full slot of the at least one of the uplink configured slots or the downlink configured slots for the at least one synchronization signal block for the at least one sidelink communication, wherein the slot index is identified in the information based on at least a frequency and a number of slots of a radio frame for slot index for the at least one synchronization signal block for communication of the at least one sidelink communication, and/or wherein the configuration comprises an uplink or downlink configuration for the at least one sidelink communication as determined from a serving cell slot configuration.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows slot indexing using UL/DL slot configuration in case of in-coverage and partial coverage scenario (30 kHz sub-carrier spacing);

FIG. 2 shows slot indexing using UL/DL slot configuration in case of out of coverage scenario (30 kHz sub-carrier spacing);

FIG. 3 shows slot indexing using UL/DL slot configuration in case of in-coverage and partial coverage scenario with concatenated UL/DL slot patterns (120 kHz sub-carrier spacing);

FIG. 4 shows slot indexing using UL/DL slot configuration in case of in-coverage and partial coverage scenario with concatenated UL/DL slot patterns (120 kHz sub-carrier spacing); and

FIG. 5 shows an example covering the indexing incase of flexible slot and multiple occasions;

FIG. 6 shows a high level block diagram of various devices used in carrying out various aspects of the invention; and

FIG. 7A and FIG. 7B each show a method in accordance with example embodiments of the invention which may be performed by an apparatus.

### DETAILED DESCRIPTION

In this invention, there is proposed a novel design for performing improved timing information communications on new radio V2X Sidelink.

Example embodiments of this invention are related to 3GPP New Radio (NR) physical layer design. More specifically the embodiments of the invention can be focused on a sidelink (SL) synchronization procedure.

NR SL supports broadcast, groupcast and unicast transmissions for the in-coverage, out-of-coverage and partial-coverage scenarios [3GPP TR 38.885]. Discovery and synchronization procedures are fundamental functionalities to facilitate direct communication and to enable different transmission schemes among the UEs.

The SL synchronization includes the following:
SL synchronization signals: SL primary synchronization signal (S-PSS), SL secondary synchronization signal (S-SSS);
Physical SL broadcast channel (PSBCH); and
SL synchronization sources and procedures

S-PSS, S-SSS and PSBCH are structured in a block format, e.g. SL synchronisation signal block (S-LSSB), which supports periodic transmission. The SL-SSB has the same numerology (i.e. SCS and CP length) as PSCCH/PSSCH in a carrier, and its transmission bandwidth is within the (pre-configured) SL BWP. [3GPP TR 38.885].

In LTE V2X, PSBCH (36.331, MasterInformationBlock-SL) contents is defined to include sl-bandwidth, tdd-ConfigSL, directFrameNumber, directSubFrameNumber and inCoverage indicator.

In context of NR V2X different information content and aspects has been proposed and considered for NR SL-SSB and SL-PBCH, for example:
TDD UL/DL configuration information;
SL-BWP configuration;
Information to derive frame timing, such as slot number information, SFN; and
For beam forming support, SSB index

Alternatively, some information has been considered to be preconfigured for the UE, for example:
TDD UL/DL configuration information;
SL-BWP configuration.

It is noted that a Sidelink for is an adaptation of a core LTE standard that allows direct communication between devices without going through a Base station. A Sidelink can be used for communications rather than using different standards in different geographical regions that may even vary within a country, making interworking of different groups difficult. In addition, a sidelink may be used in conjunction with NR or conventional LTE connections to mobile networks to enable a variety of connectivity services.

For Sidelink physical layer details of the (normal) NR slot configuration are determined. Then in (normal) NR, in SIB1, UE can be configured with common UL/DL slot configuration. The DL/UL slot configuration is determined via one or two concatenated slot patterns, which repeat in time. The configuration for each pattern, where some of the slots can be defined as downlink slots (‘D’) containing only DL symbols, bi-directional (i.e. flexible) (‘X’) containing both downlink and uplink symbols or uplink only slots (‘U’) containing only UL symbols. Pattern will have a time period configured, together with sub-carrier spacing (to determine the slots). The configuration for each pattern provides the number of full DL slots (from the start of the period), the number of DL symbols immediately following the last full DL slot, the number of full UL slots (from the end of the period), and the number of UL symbols immediately preceding the first full UL slot. UE can be scheduled for DL only in DL symbols or flexible symbols. Correspondingly, UE can transmit only in UL symbols or flexible symbols. In addition, for the flexible slots (which would be the remaining slots, between DL and UL only slots), the symbol partition in the flexible slots is determined. This is determined, similarly as the slots partition in the period, by determining the number of DL only symbols (from the start of the slot) and UL only symbols (from the end of the slot). Remaining symbols in between are considered as flexible symbols.

In NR the SSB carriers the SSB index (in PBCH DMRS and in payload), indicating the location index of the given SSB. The index points to a given, fixed location in a half frame SSB candidate location pattern, enabling UE to determine the slot timing within a half-frame from the index information.

In NR V2X, due to larger flexibility there is a need to have larger amount of information to be carried by SL-PBCH, thus it would be preferable to find mechanisms to restrict the payload size of the information.

As the UL/DL slot configuration needs to cover multiple possible sub-carrier's spacing, the required size of the information may increase rather significantly. One possible option is to restrict the supported UL/DL slot configurations to few, but this will restrict the flexibility.

As noted herein, timing related information is also needed, i.e. SFN and slot number. Correspondingly, with higher subcarrier spacing the number of slots in one radio frame can be rather large, i.e. 80 slots in 10 ms with 120 kHz requiring 7 bits to be indicated.

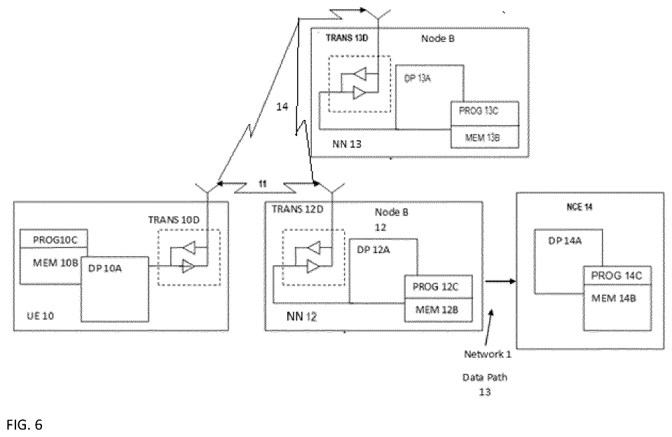

Before describing the example embodiments of the invention in detail, reference is made to FIG. 6 for illustrating a simplified block diagram of various electronic devices that are suitable for use in practicing the example embodiments of this invention.

FIG. 6 shows a block diagram of one possible and non-limiting exemplary system in which the example embodiments of the invention may be practiced. In FIG. 6, a user equipment (UE) 10 is in wireless communication with a wireless network 1. A UE is a wireless, typically mobile device that can access a wireless network. The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D are connected to one or more antennas for communication 11 and 18 to NN 12 and NN 13, respectively. The one or more memories MEM 10B include computer program code PROG 10C. The UE 10 communicates with NN 12 and/or NN 13 via a wireless link 111.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 6. The NN 12 provides access to wireless devices such as the UE 10 to the wireless network 1. The NN 12 includes one or more processors DP 12A, one or more memories MEM 12C, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D are connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13. Further, the link 11 and or any other link may be wired or wireless or both and may implement, e.g., an X2 or Xn interface. Further the link 11 may be through other network devices such as, but not limited to an NCE/MME/SGW device such as the NCE 14 of FIG. 6.

The NN 13 can comprise a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 12D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or another link. These links maybe wired or wireless or both and may implement, e.g., an X2 or Xn interface. Further, as stated above the link 11 may be through other network devices such as, but not limited to an NCE/MME/SGW device such as the NCE 14 of FIG. 6.

The one or more buses of the device of FIG. 6 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and the one or more buses 157 could be implemented in part as fiber optic cable to connect the other elements of the NN 12 to a RRH.

It is noted that although FIG. 6 shows a network nodes Such as NN 12 and NN 13. Any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 may include a network control element (NCE) 14 that may include MME (Mobility Management Entity)/SGW (Serving Gateway) functionality, and which provides connectivity with a further network, such as a telephone network and/or a data communications network (e.g., the Internet). The NN 12 and the NN 13 are coupled via a link 13 and/or link 14 to the NCE 14. In addition, it is noted that the operations in accordance with example embodiments of the invention, as performed by the NN 13, may also be performed at the NCE 14.

The NCE 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE 14 to perform one or more operations which may be needed to support the operations in accordance with the example embodiments of the invention.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In one example embodiment of the invention there is, in case of in-coverage and partial scenario, determined a slot timing of the SL-SSB based on the configured UL slots:
Where the UL-DL slot configuration is provided in SL-SSB or determined from serving cell UL-DL slot configuration; and
Where the UL slots are sequentially numbered and index/information is provided indicating the logical index of the slot where the SL SSB is sent:
   In some embodiments, flexible slots with sufficient number of UL symbols to accommodate S-SSB (including possible switching gaps) are also accounted

In an alternative example embodiment of the invention there is, for a case of out of coverage scenario, determining the slot timing of the SL-SSB based on the configured DL slots:
Where the UL-DL slot configuration is provided in SL-SSB;
   In some example embodiments the possible slots for SL-SSB transmission are indicated as DL slots in the UL-DL slot configuration
Where the DL slots are sequentially numbered and index/information is provided indicating the logical index of the slot where the SL SSB is sent:
   In some embodiments, flexible slots with sufficient number of DL symbols to accommodate S-SSB (including possible switching gaps) are also accounted

In another alternative embodiment in accordance with the invention there is, if two concatenated slot patterns are provided, consider only one of the patterns for the indexing:
Where the UL-DL slot configuration is provided in S-SSB or determined from serving cell UL-DL slot configuration; and;
Where the DL (or UL) slots in one of the UL-DL patterns is sequentially numbered over the whole pattern repetition period (e.g. 20 ms) and index/information is provided indicating the logical index of the slot where the SL SSB is sent; and
This allows the S-SSB locations to be spread over the period, with fewer bits leaving room between S-SSB(s) for data

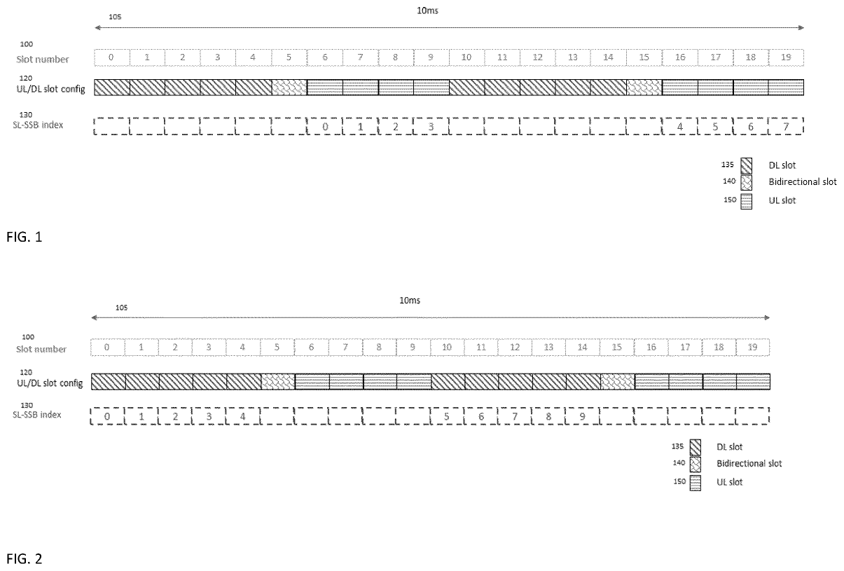

In FIG. 1 indexing of the S-SSB slot locations is illustrated for case when S-SSB can only reside in full UL slots. Thus, assuming 30 kHz then one 10 ms radio frame contains 20 slots, requiring 5 bits for providing the slot index. When only UL slots indicated by the UL-DL slot configuration are accounted the 3 bits are required to provide the slot timing.

In FIG. 1. there is shown slot indexing in accordance with an example embodiment of the invention that is using UL/DL slot configuration in case of in-coverage and partial coverage scenario (30 kHz sub-carrier spacing). As shown in FIG. 1 there is shown over 10 ms 105 slot operations of slot number 100 using UL/DL configuration 120 for S-SSB Index 130. In the UL/DL configuration 120 there is shown DL slots 135, Bidirectional Slots 140, and UL slots 150.

FIG. 2 shows slot indexing in accordance with another example embodiment of the invention that is using UL/DL slot configuration in case of out of coverage scenario (30 kHz sub-carrier spacing). As shown in FIG. 2 there is shown over 10 ms 105 slot operations of slot number 100 using UL/DL configuration 120 for S-SSB Index 130. In the UL/DL configuration 120 there is shown DL slots 135, Bidirectional Slots 140, and UL slots 150. As can be seen the S-SSB index 130 of FIG. 2 is indexed differently than in FIG. 1.

In FIG. 2 indexing of the S-SSB slot locations is illustrated for case when S-SSB can only reside in full DL slots. Thus, assuming 30 kHz then one 10 ms radio frame contains 20 slots, requiring 5 bits for providing the slot index. When only DL slots indicated by the UL-DL slot configuration are accounted the 4 bits are required to provide the slot timing.

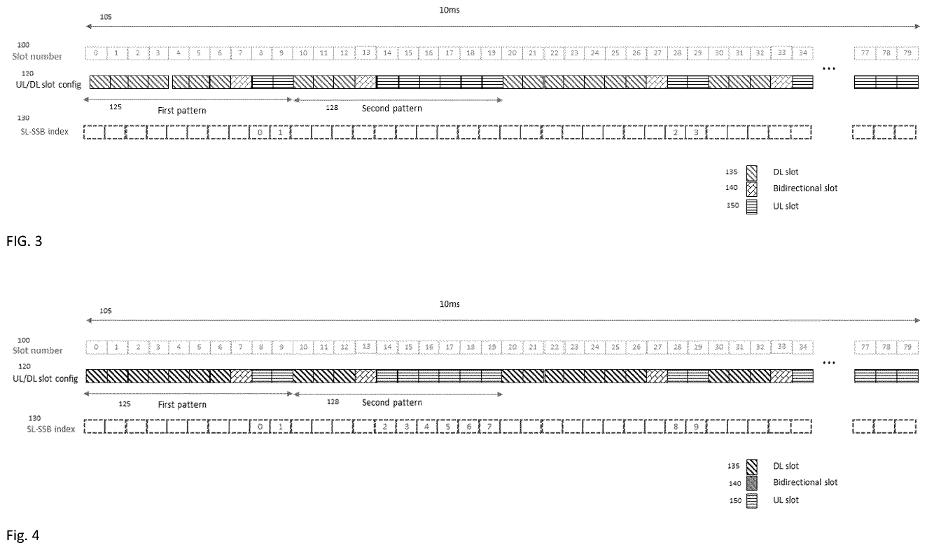

FIG. 3 shows slot indexing in accordance with another example embodiment of the invention that is using UL/DL slot configuration in case of in-coverage and partial coverage scenario with concatenated UL/DL slot patterns (120 kHz sub-carrier spacing).

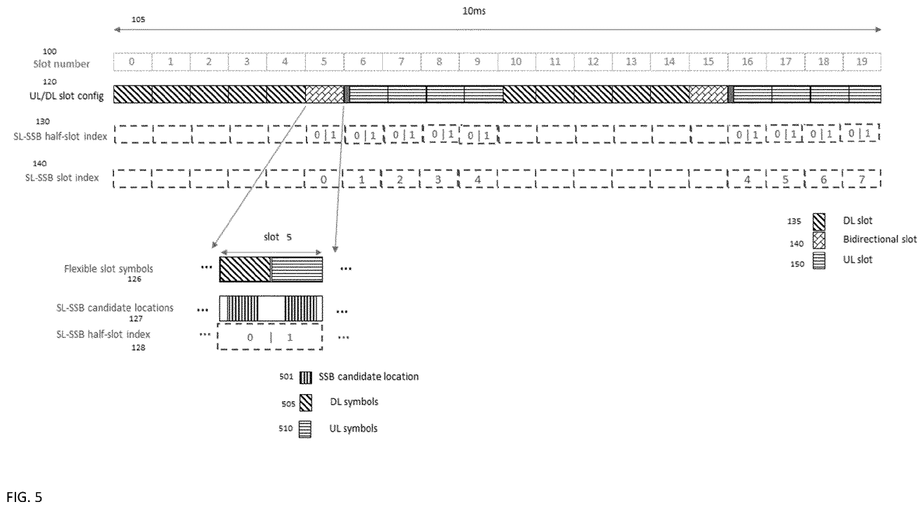

As shown in FIG. 3 there is shown over 10 ms 105 slot operations of slot number 100 using UL/DL configuration 120 for S-SSB Index 130. In the UL/DL configuration 120 there is shown DL slots 135, Bidirectional Slots 140, and UL slots 150. As can be seen the S-SSB index 130 of FIG. 4 is indexing just two slots at the end of the first pattern 125 and before the second pattern 128 of FIG. 3.

In FIG. 4. there is shown slot indexing in accordance with another example embodiment of the invention that is using UL/DL slot configuration in case of in-coverage and partial coverage scenario with concatenated UL/DL slot patterns (120 kHz sub-carrier spacing).

As shown in FIG. 4 there is shown over 10 ms 105 slot operations of slot number 100 using UL/DL configuration 120 for S-SSB Index 130. In the UL/DL configuration 120 there is shown DL slots 135, Bidirectional Slots 140, and UL slots 150. As can be seen the SL-SSB index 130 of FIG. 4 is indexing two slots at the end of the first pattern 125 and indexing six slots at the beginning of the second pattern 128 of FIG. 4.

In FIG. 4 indexing of the SL-SSB slot locations is illustrated for case when SL-SSB can only reside in full UL slots and in the first pattern. Thus, assuming 120 kHz, one 10 ms radio frame contains 80 slots and there is required 7 bits for providing the slot index. Assuming that max 10 SL-SSB are supported, and when only UL slots indicated by the UL-DL slot configuration are accounted the 4 bits are required to provide the slot timing.

In FIG. 4 indexing of the SL-SSB slot locations is illustrated for case when SL-SSB can only reside in full UL slots and in the first pattern. Thus, assuming 120 kHz then one 10 ms radio frame contains 80 slots, requiring 7 bits for providing the slot index. When only UL slots indicated by the UL-DL slot configuration are accounted the 2 bits are required to provide the slot timing. Note that in this FIG. 4 it is assumed that the maximum number of SL-SSBs supported is 4 (to keep the illustration simple), thus only 2 bits would be needed. Also, that when first 4 sequential UL slots of the first pattern (over repetitions) are valid candidate locations for the SL-SSB, they are distributed over the period, leaving UL slots free to deliver data in between.

In one possible implementation in accordance with example embodiments of the invention:
NR SL-SSB carriers UL-DL slot configuration (e.g. similar to TDD-UL-DL-ConfigurationCommon in NR) for example in SL-MIB payload,
   Alternatively, limited number of UL-DL configurations are supported to reduce the payload size similar to LTE V2X (e.g. subframeAssignmentSL in 36.331, and Table 4.2-2 in 36.211);
In addition, SL-SSB provides 3 bits to determine the SL-SSB slot index
   The number of bits required depends in the end from two factors; how many SSBs are supported (e.g. in NR this varies per frequency band) and how much flexibility is desired for the SL-SSB location selection (i.e. number of candidate locations); and
Based on acquiring aforementioned information and SFN (also assumed to be provided by SL-MIB), UE determines the slot timing of the received SL-SSB.
   Taking FIG. 1 as an example, UE is provided with UL/DL slot configuration as depicted, and SL-SSB slot index of 3. Based on this UE can determine that the received SL-SSB was sent in slot number 9 (in 10 ms radio frame).

In FIG. 5 there is shown an example covering the indexing incase of flexible slot and multiple occasions. As shown in FIG. 5 there is shown over 10 ms 105 slot operations of slot number 100 using UL/DL configuration 120 for SL-SSB Half Slot Index 130 and for SL-SSB Slot Index 140. As shown in FIG. 5, Slot 5 can include flexible slot symbols 126, SL-SSB candidate locations 127, and SL-SSB half slot index 128. As shown in FIG. 5 there is shown at least for slot 5 SSB candidate location 510, DL symbols 505, and UL symbols 510 in the flexible slot 5 as in FIG. 5.

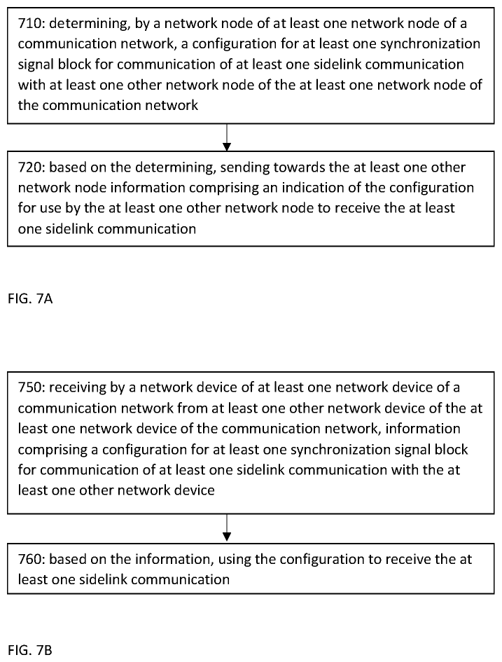

FIG. 7A illustrates operations which may be performed by a device such as, but not limited to, a device associated with the UE 10, NN 12, and/or NN 13 as in FIG. 6. As shown in step 710 of FIG. 7A there is determining, by a network node of at least one network node of a communication network, a configuration for at least one synchronization signal block for communication of at least one sidelink communication with at least one other network node of the at least one network node of the communication network. As shown in step 720 of FIG. 7A there is, based on the determining, sending towards the at least one other network node information comprising an indication of the configuration for use by the at least one other network node to receive the at least one sidelink communication.

In accordance with the example aspect of the example embodiments of the invention as disclosed in the paragraph above, wherein the determined configuration comprises at least one configuration for slot timing of the at least one synchronization signal block for communication of the at least one sidelink communication.

In accordance with the example aspect of the example embodiments of the invention as disclosed in the paragraphs above, wherein the slot timing is based on at least one of uplink configured slots or downlink configured slots.

In accordance with the example aspect of the example embodiments of the invention as disclosed in the paragraphs above, wherein the information comprises an indication of the at least one of the uplink configured slots or the downlink configured slots for the at least one synchronization signal block for the communication of the at least one sidelink communication.

In accordance with the example aspect of the example embodiments of the invention as disclosed in the paragraphs above, wherein the determining the configuration comprises determining flexible slots of the at least one of the uplink configured slots or the downlink configured slots to accommodate the at least one sidelink communication.

In accordance with the example aspect of the example embodiments of the invention as disclosed in the paragraphs above, wherein the information comprises the at least one of the uplink configured slots or the downlink configured slots are identified by numbering at least to indicate a logical index of at least one slot for the at least one synchronization signal block for the communication of the at least one sidelink communication.

In accordance with the example aspect of the example embodiments of the invention as disclosed in the paragraphs above, wherein the flexible slots of the at least one slot for the at least one synchronization signal comprises one of partial or full slots of the at least one of the uplink configured slots or the downlink configured slots.

In accordance with the example aspect of the example embodiments of the invention as disclosed in the paragraphs above, wherein a validity of the flexible slots is dependent on a time division allocation of the at least one sidelink communication fitting into the uplink configured slots.

In accordance with the example aspect of the example embodiments of the invention as disclosed in the paragraphs above, wherein fitting is accounting for reception and transmission switching gaps of the flexible slots.

In accordance with the example aspect of the example embodiments of the invention as disclosed in the paragraphs above, wherein the numbering is over a whole pattern repetition period associated with the at least one of the uplink configured slots or the downlink configured slots.

In accordance with the example aspect of the example embodiments of the invention as disclosed in the paragraphs above, wherein the whole pattern repetition period is 20 ms.

In accordance with the example aspect of the example embodiments of the invention as disclosed in the paragraphs above, wherein the determining the configuration comprises: determining at least one full slot of the at least one of the uplink configured slots or the downlink configured slots for the at least one sidelink communication; and based on at least the determined at least one slot, determining a slot index of at least one slot for the at least one synchronization signal block for the communication of the at least one sidelink communication.

In accordance with the example aspect of the example embodiments of the invention as disclosed in the paragraphs above, wherein the slot index is identified in the information based on at least a frequency and a number of slots of a radio frame for slot index for communication of the at least one sidelink communication.

In accordance with the example aspect of the example embodiments of the invention as disclosed in the paragraphs above, wherein the determined configuration comprises an uplink or downlink configuration for the at least one sidelink communication as determined from a serving cell slot configuration.

In accordance with the example aspect of the example embodiments of the invention as disclosed in the paragraphs above, wherein the least one network node of the communication network comprises at least one user equipment.

A non-transitory computer-readable medium (MEM 12B and/or MEM 13B as in FIG. 6) storing program code (PROG 10C, PROG 12C, and/or PROG 13C as in FIG. 6), the program code executed by at least one processor (DP 10A, DP 12A, and/or DP 13A as in FIG. 6) to perform the operations as at least described in the paragraphs above.

In accordance with an example embodiment of the invention as described above there is an apparatus comprising: means for determining (TRANS 10D, TRANS 12D, and/or TRANS 13D; MEM 10B, MEM 12B, and/or MEM 13B; PROG 10C, PROG 12C, and/or PROG 13C; and DP 10A, DP 12A, and/or DP 13A as in FIG. 6), by a network node of at least one network node (UE 10, NN 12, and/or NN 13 as in FIG. 6) of a communication network (network 1 as in FIG. 6), a configuration for at least one synchronization signal block for communication of at least one sidelink communication with at least one other network node of the at least one network node of the communication network; and means, based on the determining, for sending (TRANS 10D, TRANS 12D, and/or TRANS 13D; MEM 10B, MEM 12B, and/or MEM 13B; PROG 10C, PROG 12C, and/or PROG 13C; and DP 10A, DP 12A, and/or DP 13A as in FIG. 6), by a network node (UE 10, NN 12, and/or NN 13 as in FIG. 6) towards the at least one other network node information comprising an indication of the configuration for use by the at least one other network node to receive the at least one sidelink communication.

In the example aspect of the invention according to the paragraph above, wherein at least the means for determining, configuring, and sending comprises a transceiver [TRANS 10D, TRANS 12D, and/or TRANS 13D as in FIG. 6] a non-transitory computer readable medium [MEM 10B, MEM 12B, and/or MEM 13B] encoded with a computer program [PROG 10C, PROG 12C, and/or PROG 13C as in FIG. 6] executable by at least one processor [DP 10A, DP 12A, and/or DP 13A as in FIG. 6].

FIG. 7B illustrates operations which may be performed by a device such as, but not limited to, a device (e.g., NN 12, NN 13, and/or UE 10 as in FIG. 6). As shown in step 750 of FIG. 7B there is receiving by a network device of at least one network device of a communication network, from at least one other network device of the at least one network device of the communication network, information comprising a configuration for at least one synchronization signal block for communication of at least one sidelink communication with the at least one other network device. Then as shown in step 760 of FIG. 7B there is, based on the information, using the configuration to receive the at least one sidelink communication.

In accordance with the example aspect of the example embodiments of the invention as disclosed in the paragraph above, wherein the determined configuration comprises at least one configuration for slot timing of the at least one synchronization signal block for communication of the at least one sidelink communication.

In accordance with the example aspect of the example embodiments of the invention as disclosed in the paragraphs above, wherein the slot timing is based on at least one of uplink configured slots or downlink configured slots.

In accordance with the example aspect of the example embodiments of the invention as disclosed in the paragraphs above, wherein the information comprises an indication of the at least one of the uplink configured slots or the downlink configured slots for the at least one synchronization signal block for the communication of the at least one sidelink communication.

In accordance with the example aspect of the example embodiments of the invention as disclosed in the paragraphs above, wherein the information comprises an indication of flexible slots of the at least one of the uplink configured slots or the downlink configured slots accommodating the at least one synchronization signal block for the at least one sidelink communication.

In accordance with the example aspect of the example embodiments of the invention as disclosed in the paragraphs above, wherein the information comprises the at least one of the uplink configured slots or the downlink configured slots are identified by numbering at least to indicate a logical index of at least one slot for the at least one synchronization signal block for the communication of the at least one sidelink communication.

In accordance with the example aspect of the example embodiments of the invention as disclosed in the paragraphs above, wherein the flexible slots of the at least one slot for the at least one synchronization signal comprises one of partial or full slots of the at least one of the uplink configured slots or the downlink configured slots.

In accordance with the example aspect of the example embodiments of the invention as disclosed in the paragraphs above, wherein a validity of the flexible slots is dependent on a time division allocation of the at least one sidelink communication fitting into the uplink configured slots.

In accordance with the example aspect of the example embodiments of the invention as disclosed in the paragraphs above, wherein fitting is accounting for reception and transmission switching gaps of the flexible slots.

In accordance with the example aspect of the example embodiments of the invention as disclosed in the paragraphs above, wherein the numbering is over a whole pattern repetition period associated with the at least one of the uplink configured slots or the downlink configured slots.

In accordance with the example aspect of the example embodiments of the invention as disclosed in the paragraphs above, wherein the whole pattern repetition period is 20 ms.

In accordance with the example aspect of the example embodiments of the invention as disclosed in the paragraphs above, wherein the information comprises a slot index of at least one slot for the communication of the at least one sidelink communication, wherein the slot index is based on at least one full slot of the at least one of the uplink configured slots or the downlink configured slots for the at least one synchronization signal block for the at least one sidelink communication.

In accordance with the example aspect of the example embodiments of the invention as disclosed in the paragraphs above, wherein the slot index is identified in the information based on at least a frequency and a number of slots of a radio frame for slot index for the at least one synchronization signal block for communication of the at least one sidelink communication.

In accordance with the example aspect of the example embodiments of the invention as disclosed in the paragraphs above, wherein the configuration comprises an uplink or downlink configuration for the at least one sidelink communication as determined from a serving cell slot configuration.

In accordance with the example aspect of the example embodiments of the invention as disclosed in the paragraphs above, wherein the least one network device of the communication network comprises at least one user equipment.

A non-transitory computer-readable medium (MEM 12B and/or MEM 13B as in FIG. 6) storing program code (PROG 10C, PROG 12C, and/or PROG 13C as in FIG. 6), the program code executed by at least one processor (DP 10A, DP 12A, and/or DP 13A as in FIG. 6) to perform the operations as at least described in the paragraphs above.

In accordance with an example embodiment of the invention as described above there is an apparatus comprising: means for receiving (TRANS 10D, TRANS 12D, and/or TRANS 13D; MEM 10B, MEM 12B, and/or MEM 13B; PROG 10C, PROG 12C, and/or PROG 13C; and DP 10A, DP 12A, and/or DP 13A as in FIG. 6) by a network device of at least one network device (NN 12, NN 13, and/or UE 10 as in FIG. 6) of a communication network (Network 1 as in FIG. 6), information comprising a configuration for at least one synchronization signal block for communication of at least one sidelink communication with the at least one other network device of the at least one network device; and means, based on the information, for using (TRANS 10D, TRANS 12D, and/or TRANS 13D; MEM 10B, MEM 12B, and/or MEM 13B; PROG 10C, PROG 12C, and/or PROG 13C; and DP 10A, DP 12A, and/or DP 13A as in FIG. 6) the configuration to receive the at least one sidelink communication.

In the example aspect of the invention according to the paragraph above, wherein at least the means for receiving, and using comprises a transceiver [TRANS 10D, TRANS 12D, and/or TRANS 13D as in FIG. 6] a non-transitory computer readable medium [MEM 10B, MEM 12B, and/or MEM 13B] encoded with a computer program [PROG 10C, PROG 12C, and/or PROG 13C as in FIG. 6] executable by at least one processor [DP 10A, DP 12A, and/or DP 13A as in FIG. 6].

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

As used in this application, the term ‘circuitry’ refers to all of the following:

(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A method, comprising:
determining, by a network node of a communication network, a configuration for at least one synchronization signal block for communication of at least one sidelink communication with at least one user equipment of the communication network; and
based on the determining, sending towards the user equipment information comprising an indication of the configuration for use by the user equipment to receive the at least one sidelink communication.

2. The method of claim 1, wherein the determined configuration comprises at least one configuration for slot timing of the at least one synchronization signal block for communication of the at least one sidelink communication.

3. The method of claim 2, wherein the slot timing is based on at least one of uplink configured slots or downlink configured slots.

4. The method of claim 3, wherein the information comprises an indication of the at least one of the uplink configured slots or the downlink configured slots for the at least one synchronization signal block for the communication of the at least one sidelink communication.

5. The method of claim 4, wherein the determining the configuration comprises determining flexible slots of the at least one of the uplink configured slots or the downlink configured slots to accommodate the at least one sidelink communication.

6.-14. (canceled)

15. An apparatus, comprising:
at least one processor; and
at least one non-transitory memory including computer program code, where the at least one memory and the computer program code are configured, with the at least one processor, to cause the apparatus to at least:
determine, by a network node of a communication network, a configuration for at least one synchronization signal block for communication of at least one sidelink communication with at least one user equipment of the communication network; and
based on the determining, send towards the user equipment information comprising an indication of the configuration for use by the user equipment to receive the at least one sidelink communication.

16. The apparatus of claim 15, wherein the determined configuration comprises at least one configuration for slot timing of the at least one synchronization signal block for communication of the at least one sidelink communication.

17. The apparatus of claim 16, wherein the slot timing is based on at least one of uplink configured slots or downlink configured slots.

18. The apparatus of claim 17, wherein the information comprises an indication of the at least one of the uplink configured slots or the downlink configured slots for the at least one synchronization signal block for the communication of the at least one sidelink communication.

19. The apparatus of claim 18, wherein the determining the configuration comprises determining flexible slots of the at least one of the uplink configured slots or the downlink configured slots to accommodate the at least one sidelink communication.

20.-28. (canceled)

29. A method, comprising:
receiving from user equipment of a communication network, by a network device of the communication network, information comprising a configuration for at least one synchronization signal block for communication of at least one sidelink communication with the user equipment; and
based on the information, using the configuration to receive the at least one sidelink communication.

30. The method of claim 29, wherein the determined configuration comprises at least one configuration for slot timing of the at least one synchronization signal block for communication of the at least one sidelink communication.

31. The method of claim 30, wherein the slot timing is based on at least one of uplink configured slots or downlink configured slots.

32. The method of claim 31, wherein the information comprises an indication of the at least one of the uplink configured slots or the downlink configured slots for the at least one synchronization signal block for the communication of the at least one sidelink communication.

33. The method of claim 32, wherein the information comprises an indication of flexible slots of the at least one of the uplink configured slots or the downlink configured slots accommodating the at least one synchronization signal block for the at least one sidelink communication.

34.-42. (canceled)

43. An apparatus, comprising:
at least one processor; and
at least one non-transitory memory including computer program code, where the at least one memory and the computer program code are configured, with the at least one processor, to cause the apparatus to at least:
receive from user equipment of a communication network, by a network device of the communication network, information comprising a configuration for at least one synchronization signal block for communication of at least one sidelink communication with the user equipment; and
based on the information, use the configuration to receive the at least one sidelink communication.

44. The apparatus of claim 43, wherein the determined configuration comprises at least one configuration for slot timing of the at least one synchronization signal block for communication of the at least one sidelink communication.

45. The apparatus of claim 44, wherein the slot timing is based on at least one of uplink configured slots or downlink configured slots.

46. The apparatus of claim 45, wherein the information comprises an indication of the at least one of the uplink configured slots or the downlink configured slots for the at least one synchronization signal block for the communication of the at least one sidelink communication.

47. The apparatus of claim 46, wherein the information comprises an indication of flexible slots of the at least one of the uplink configured slots or the downlink configured slots accommodating the at least one synchronization signal block for the at least one sidelink communication.

48.-56. (canceled)
